(19) United States
(12) Patent Application Publication
(10) Pub. No.: US 2011/0097199 A1
(43) Pub. Date: Apr. 28, 2011

(54) SYSTEM AND METHOD TO INSULATE TURBINES AND ASSOCIATED PIPING

(76) Inventors: Henry G. BALLARD, JR., Easley, SC (US); Lewis Berkley DAVIS, JR., Schenectady, NY (US); Gary Charles LIOTTA, Simpsonville, SC (US)

(21) Appl. No.: 12/606,694

(22) Filed: Oct. 27, 2009

(51) Int. Cl. F02C 7/24; B23P 11/00

(52) U.S. Cl. 415/177; 29/889.2

(57) ABSTRACT

An insulation system includes at least one turbine insulation compartment configured to enclose at least a portion of a turbine; an insulation storage compartment configured to store a supply of insulation; a plurality of first pipes that connect to the turbine insulation compartment and the insulation storage compartment; and a blower configured to generate a flow of air in at least one first pipe to pneumatically convey insulation between the insulation storage compartment and the at least one turbine insulation compartment. A method of insulating at least a portion of a turbine includes enclosing at least a portion of the turbine in a compartment; and conveying insulation into the compartment.

The present invention relates to systems and methods to insulate gas turbines and associated piping.

### BACKGROUND OF THE INVENTION

Turbines, for example gas turbines, can lose heat through the uninsulated exterior of the compressor, compressor discharge, turbine, and exhaust frame casings. Typically such heat loss can be significant during long term operation, with the heat being removed from the stator-tube exterior by convection to the enclosure ventilation system.

Turbine insulation generally includes blankets or loose fill insulation encapsulated in soft or hard packs. Numerous custom shaped packs are required to cover the stator tube. Piping insulation is typically a split tube design with custom formed packs for elbows, tees, and other non-cylindrical piping features. Such insulation packs need to be removed to inspect piping for leakages and installing and removing insulation to the stator tube exterior and associated piping is a labor intensive process.

### BRIEF DESCRIPTION OF THE INVENTION

According to a sample embodiment, an insulation system comprises at least one turbine insulation compartment configured to enclose at least a portion of a turbine; an insulation storage compartment configured to store a supply of insulation; a plurality of first pipes that connect to the at least one turbine insulation compartment and the insulation storage compartment; and a blower configured to generate a flow of air in at least one pipe to pneumatically convey insulation between the insulation storage compartment and the at least one turbine insulation compartment.

According to another sample embodiment, a method of insulating at least a portion of a turbine comprises enclosing at least a portion of the turbine in a compartment; and conveying insulation into the compartment.

### BRIEF DESCRIPTION OF THE DRAWINGS

FIG. 1 schematically depicts an insulation system according to a sample embodiment;

FIG. 2 schematically depicts a turbine component and an insulation compartment according to a sample embodiment;

FIG. 3 schematically depicts an insulation compartment including a plurality of sub-compartments according to a sample embodiment;

FIG. 4 schematically depicts a detail of a seal at a coupling of insulation compartments;

FIG. 5 schematically depicts a sub-compartment of an insulation compartment according to a sample embodiment;

FIG. 6 schematically depicts a sub-compartment of an insulation compartment according to a sample embodiment;

FIG. 7 schematically depicts an insulation system including turbine component and associated piping insulation compartments; and

FIGS. 8 and 9 schematically depict an insulation system including a turbine insulation compartment according to a sample embodiment.

### DETAILED DESCRIPTION OF THE INVENTION

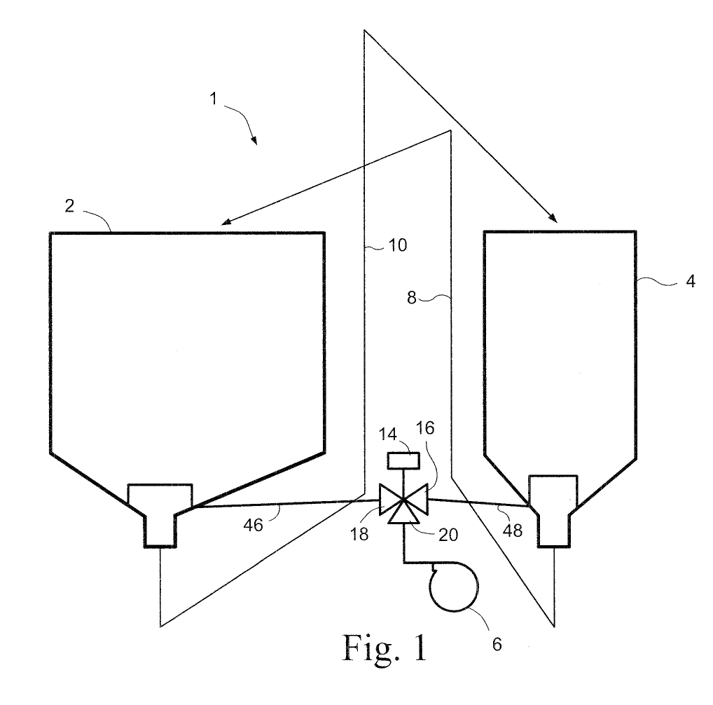

Referring to FIG. 1, an insulation system 1 according to a sample embodiment is provided for insulating a turbine, or certain components or portions of a turbine, and/or piping associated with the turbine or the components of the turbine. The insulation system 1 includes a turbine insulation compartment 2 which may enclose a turbine, or components or portions of the turbine. An insulation storage compartment, or silo, 4 is configured to contain insulation. The insulation may comprise powders, hollow, solid, composite, or foam beads, spheres, fibers, or prisms.

The insulation is fluidized to allow for pneumatic transport or conveyance of the insulation from the insulation storage compartment 4 to the turbine insulation compartment 2.

A blower 6 generates airflow to fluidize and transport the insulation from the insulation storage compartment 4 to the turbine insulation compartment 2, and vice versa. The airflow from the blower 6 is controlled by valves 16, 18, 20 which are controlled by a control 14. The control 14 may be, for example, a programmed computer or an electronic processor programmed to open and close the valves 16, 18, 20.

Insulation feed pipes 8 are provided from the insulation storage compartment 4 to the turbine insulation compartment 2 to feed the insulation from the insulation storage compartment 4 to the turbine insulation compartment 2. Insulation return pipes 10 are provided to return insulation from the turbine insulation compartment 2 to the insulation storage compartment 4.

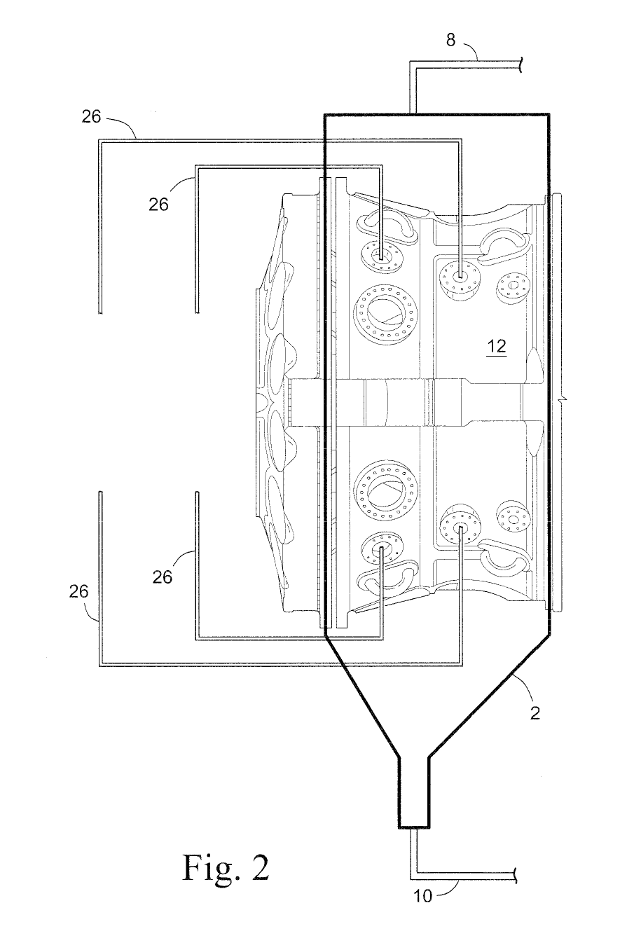

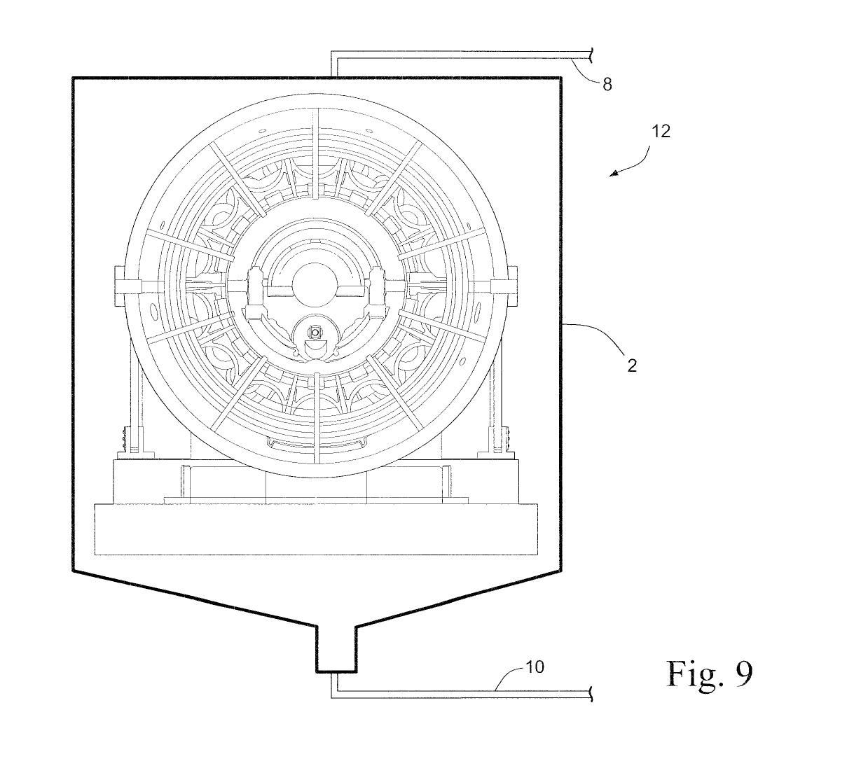

Referring to FIGS. 2, and 7-9, a turbine, or a component of a turbine, 12 is enclosed within the turbine insulation compartment 2. The insulation feed pipes 8 are configured to deliver insulation into the turbine insulation compartment 2 and the insulation return pipes 10 are configured to deliver the insulation from a turbine insulation compartment 2 to the insulation storage compartment 4.

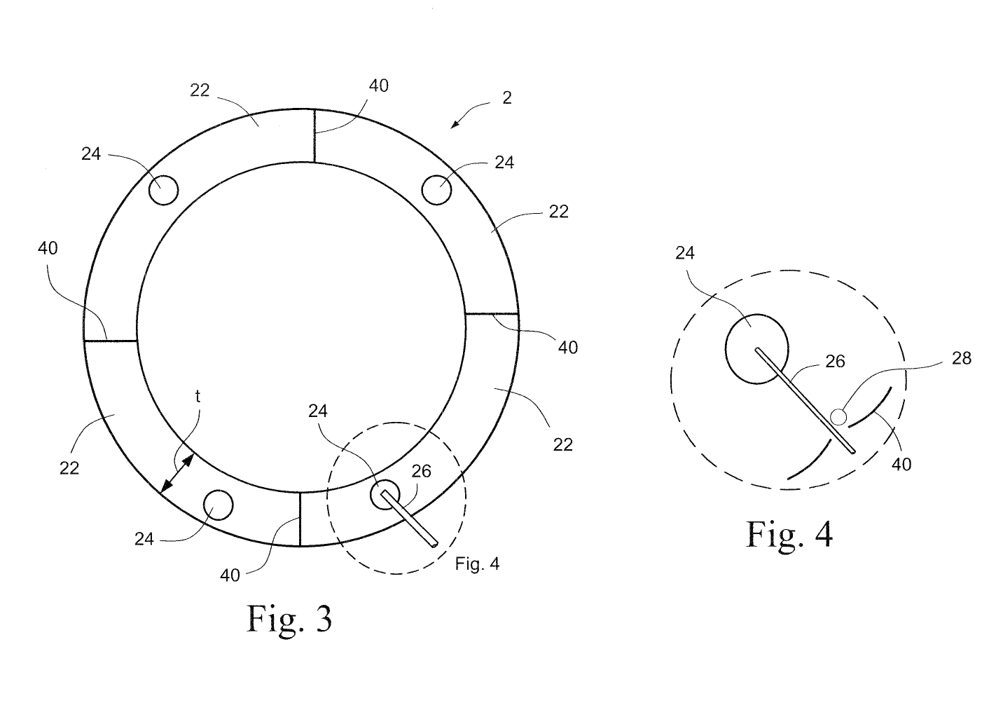

Referring to FIG. 3, the turbine insulation compartment 2 may comprise a plurality of sub-compartments 22. Each sub-compartment 22 may comprise a connector, or coupling, 24 (e.g. a pipe flange) so that the turbine insulation compartment 2 may be connected to another turbine insulation compartment. Each connector, or coupling 24, may include a seal 26 that is provided to prevent insulation 28, for example, a bead or sphere, from being released from the sub-compartment 22. In addition, the sub-compartments 22 are separated by sub-compartment boundaries 40. The gaps in the sub-compartment boundaries 40 are smaller than the insulation 28 so that the insulation 28 cannot pass through. In this way, sealing between sub-compartment boundaries 40 does not require the sub-compartments 22 to have exact fits. The sub-compartment boundaries 40 may be fabric or mesh material with openings smaller than the insulation 28 to provide junctions and flexible connections between the sub-compartments 22.

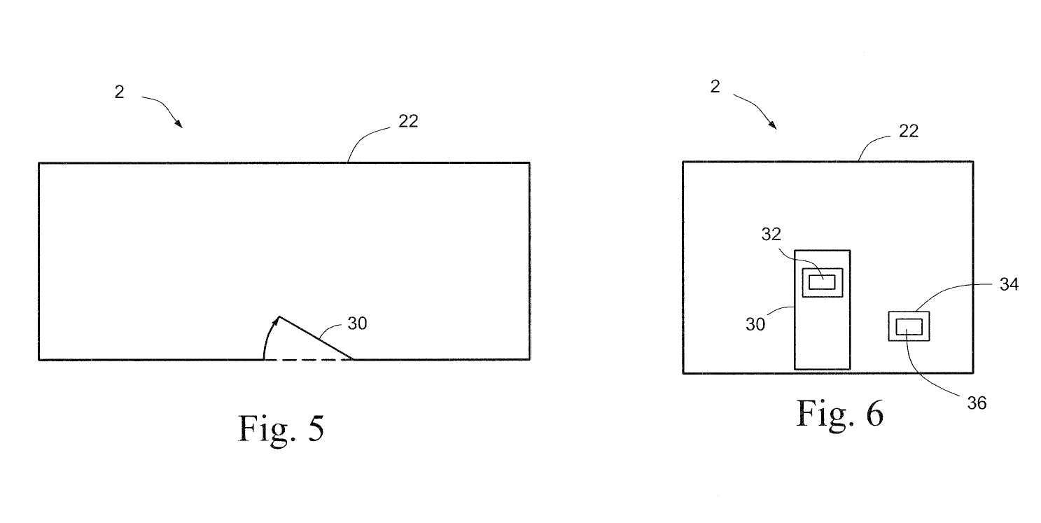

Referring to FIGS. 5 and 6, each sub-compartment 22 of the turbine insulation compartment 2 may comprise a door 30 that may be opened to permit access to and/or inspection of the turbine components provided within the turbine insulation compartment 2. As shown in FIG. 5, the door 30 opens towards an interior of the sub-compartment 22 to prevent the door 30 from being opened in the event that the sub-compartment contains insulation.

As shown in FIG. 6, the door 30 may include a window 32 to allow visual inspection of the turbine components or the insulation without the need for opening the door 30. In addition, the sub-compartment 22 may also include a hatch 34 that includes a window 36 to also allow visible inspection of the turbine components and/or insulation contained within the sub-compartment 22.

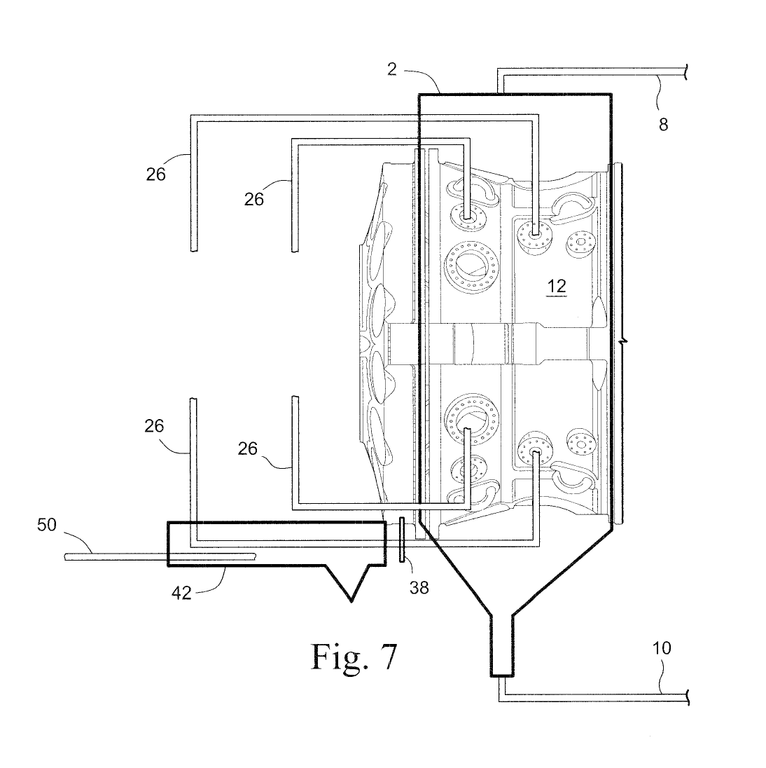

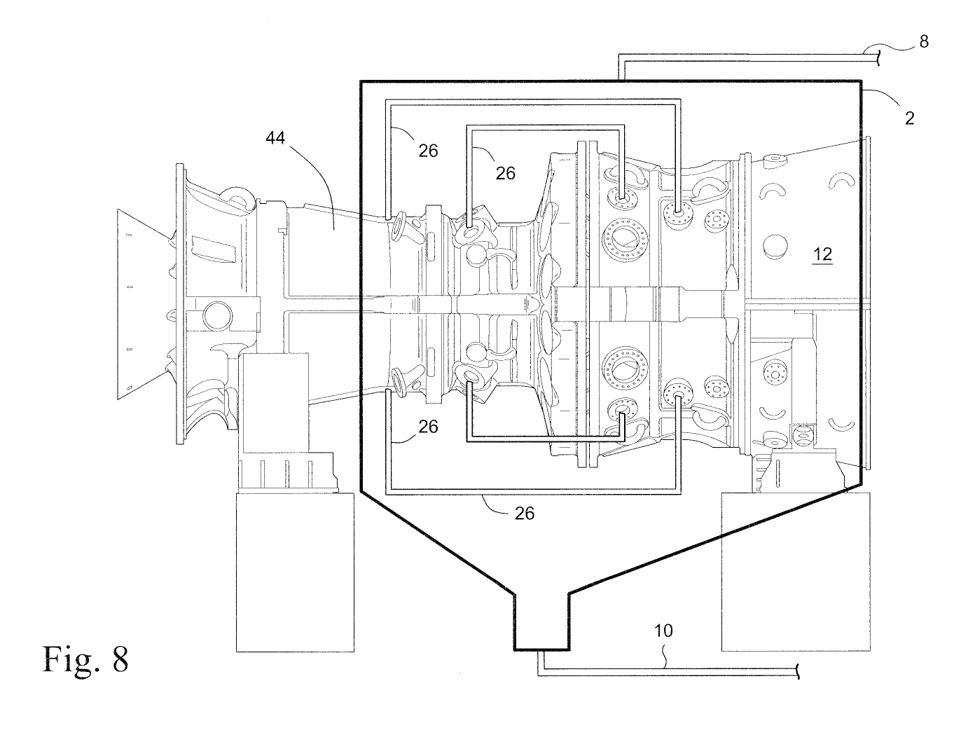

Referring to FIG. 7, a plurality of insulation compartments 2, 42 may be provided. A turbine insulation compartment 2 may be provided to enclose a turbine, or a component or components of a turbine, 12. A piping insulation compartment 42 may be provided for insulating piping associated with the turbine, for example, the insulation return pipe 10. An uncovered area 38 may be provided between the insulation compartments 2, 42. The uncovered area 38 may comprise, for example, flanges in fuel and oil lines. As shown in FIG. 8, a portion or component or components of the turbine, for example a vane guide section 44, may not be insulated. The components of the turbine that are enclosed by the turbine insulation compartment(s) 2 may include, for example, the stator.

The turbine insulation compartments 2, including the sub-compartments 22, may be compartmentalized to insulate various turbine components, thus allowing each turbine component an optimal insulation thickness t (FIG. 3). Moreover, some turbine components may require service access at different time intervals than other components and the compartmentalization allows access to such components, without having to remove the insulation from components which are not being serviced.

The optimum thickness t around each turbine component may be different than that required for other components. Similarly, insulation compartments may be provided to some pipes, or groups of pipes, while others may be uncovered, for example those pipes which require frequent inspection.

The insulation system provides a larger reduction in heat loss than prior art systems, for example insulation blankets. The transport of the insulation to the turbine insulation compartments and the piping insulation compartments, as well as the removal and re-transportation of the insulation, may be automated to reduce outage time of the turbine.

Compartmentalization of the insulation also provides deterministic thermal boundary conditions at specific locations and reduces the volume of insulation required, while allowing access to specific locations.

The insulation system may use any dry insulation capable of pneumatic conveyance. For example, such dry insulation may be in the form of powders, beads, spheres, fibers or prisms, which may in turn be composed of solid, foam or composite interiors.

Pneumatic conveyance of the insulation reduces, or eliminates, manual labor to install, remove, or re-install insulation, while providing substantial insulation thicknesses. The insulation of a turbine, or components of the turbine, by adding insulation to turbine insulation compartments reduces fuel consumption and thermal gradients in stator to casings.

While the invention has been described in connection with what is presently considered to be the most practical and preferred embodiment, it is to be understood that the invention is not to be limited to the disclosed embodiments, but on the contrary, is intended to cover various modifications and equivalent arrangements included within the spirit and scope of the appended claims.

What is claimed is:

1. An insulation system, comprising:
at least one turbine insulation compartment configured to enclose at least a portion of a turbine;
an insulation storage compartment configured to store a supply of insulation;
a plurality of first pipes that connect to the at least one turbine insulation compartment and the insulation storage compartment; and
a blower configured to generate a flow of air in at least one first pipe to pneumatically convey insulation between the insulation storage compartment and the at least one turbine insulation compartment.

2. An insulation system according to claim 1, wherein turbine insulation compartment comprises a plurality of sub-compartments.

3. An insulation system according to claim 2, wherein the sub-compartments are separated by a boundary comprising sheet, fabric or mesh.

4. An insulation system according to claim 1, further comprising:
a plurality of turbine insulation compartments connected by couplings.

5. An insulation system according to claim 4, further comprising:
seals configured to prevent insulation from passing from one turbine insulation compartment to another turbine insulation compartment.

6. An insulation system according to claim 1, wherein the at least one turbine insulation compartment comprises at least one of a door and a hatch.

7. An insulation system according to claim 6, wherein the at least one of a door and a hatch open into the at least one turbine insulation compartment.

8. An insulation system according to claim 6, wherein the at least one of a door and a hatch comprises a window.

9. An insulation system according to claim 1, further comprising:
a plurality of valves configured to control the air flow in the plurality of first pipes.

10. An insulation system according to claim 9, further comprising:
a control configured to control opening and closing of the plurality of valves.

11. An insulation system according to claim 1, further comprising:
a pipe insulation compartment configured to enclose at least part of at least one first pipe and/or at least part of at least one second pipe connected to the turbine.

12. An insulation system according to claim 1, wherein the supply of insulation comprises powders, beads, spheres, fibers, which are comprised of solid, hollow, foam or composite interiors.

13. A method of insulating at least a portion of a turbine, the method comprising:
enclosing at least a portion of the turbine in a compartment; and
pneumatically conveying insulation into the compartment.

14. A method according to claim 13, further comprising:
pneumatically conveying insulation out of the compartment.

15. A method according to claim 13, wherein conveying the insulation comprises pneumatically conveying the insulation.

16. A method according to claim 15, wherein pneumatically conveying the insulation comprises generating a flow of air in at least one pipe connected to the compartment.

17. A method according to claim 16, further comprising controlling the flow of air in the at least one pipe with at least one valve.

18. A method according to claim 13, wherein the compartment comprises a plurality of sub-compartments, and pneumatically conveying the insulation comprises conveying insulation to each sub-compartment.

19. A method according to claim 18, wherein the sub-compartments have different thicknesses.

20. A method according to claim 13, wherein the insulation comprises powders, spheres, fibers, and/or solid prisms which are comprised of solid, hollow, foam or composite interiors.
